(19) United States
(12) Patent Application Publication
(10) Pub. No.: US 2026/0031316 A1
(43) Pub. Date: Jan. 29, 2026

(54) METHOD AND APPARATUS FOR LIGHT GENERATION

(71) Applicant: Excelitas Technologies Corp., Pittsburgh, PA (US)

(72) Inventor: Miodrag Cekic, Bethesda, MD (US)

(73) Assignee: Excelitas Technologies Corp., Pittsburgh, PA (US)

(21) Appl. No.: 19/265,939

(22) Filed: Jul. 10, 2025

Related U.S. Application Data
(60) Provisional application No. 63/676,298, filed on Jul. 26, 2024.

(51) Int. Cl. H01J 65/04; H01J 61/38; H01J 61/54

(52) U.S. Cl. CPC H01J 65/044; H01J 61/38; H01J 61/54

(57) ABSTRACT

The techniques described herein relate to systems, apparatus, articles of manufacture, and methods for light generation. An example apparatus for ultraviolet (UV) radiation generation includes a microwave cavity comprising an electrodeless UV bulb, the electrodeless UV bulb comprising a bulb fill capable of emitting UV light, a synthesizer configured to generate a microwave signal, and a solid-state amplifier configured to amplify the microwave signal to generate an amplified microwave signal for igniting the bulb fill to emit UV light.

### RELATED APPLICATION

This patent claims priority under 35 U.S.C. § 119(e) to U.S. Provisional Application No. 63/676,298, filed on Jul. 26, 2024, which is hereby incorporated by reference herein in its entirety.

### FIELD

The techniques described herein relate generally to ultraviolet light emission and, more particularly, to systems, apparatus, articles of manufacture, and methods for light generation.

### BACKGROUND

Ultraviolet (UV) lamp systems are capable of emitting UV light based on the excitation of a gas or gas mixture. Some such UV lamp systems are used in a variety of applications such as for drying and solvents removal, material processing, and surface cleaning.

### SUMMARY

In accordance with the disclosed subject matter, apparatus, systems, and methods are provided for light generation.

Some embodiments relate to an apparatus for ultraviolet (UV) radiation generation comprising a microwave cavity comprising an electrodeless UV bulb, the electrodeless UV bulb comprising a bulb fill capable of emitting UV light, a synthesizer configured to generate a microwave signal, and a solid-state amplifier configured to amplify the microwave signal to generate an amplified microwave signal for igniting the bulb fill to emit UV light.

Some embodiments relate to a method for generating UV radiation comprising generating a microwave signal, amplifying, with a solid-state amplifier, the microwave signal to generate an amplified microwave signal for output to an electrodeless UV bulb, the electrodeless UV bulb comprising a bulb fill capable of emitting UV light, and igniting the bulb fill to emit UV light, by: (i) driving the solid-state amplifier to generate the amplified microwave signal with a first amplitude meeting or exceeding a first amplitude threshold for a first time period, (ii) driving the solid-state amplifier to generate the amplified microwave signal with a second amplitude meeting or falling below a second amplitude threshold for a second time period, after the first time period, and iteratively performing (i) and (ii) until the bulb fill is ignited.

Some embodiments relate to a system for UV radiation generation comprising a microwave cavity comprising an electrodeless UV bulb, the electrodeless UV bulb comprising a bulb fill capable of emitting UV light, a synthesizer configured to generate a microwave signal, a solid-state amplifier configured to amplify the microwave signal to generate an amplified microwave signal, and a conduit configured to provide the amplified microwave signal to the electrodeless UV bulb for igniting the bulb fill to emit UV light.

The foregoing summary is not intended to be limiting. Moreover, various aspects of the present disclosure may be implemented alone or in combination with other aspects.

### BRIEF DESCRIPTION OF FIGURES

Various aspects and embodiments of the present technology will be described with reference to the following figures. In the figures, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 illustrates an example ultraviolet (UV) lamp system including magnetrons, in accordance with some embodiments of the technology described herein.

FIG. 2A illustrates an arrangement of magnetrons and radiofrequency/microwave (RF/MW) conduits, in accordance with some embodiments of the technology described herein.

FIG. 2B illustrates an arrangement of solid-state amplifiers and RF/MW conduits, in accordance with some embodiments of the technology described herein.

FIG. 3 illustrates an example UV lamp system including solid-state amplifiers, in accordance with some embodiments of the technology described herein.

FIG. 4 is a schematic illustration of an example implementation of the UV lamp system of FIG. 3, in accordance with some embodiments of the technology described herein.

FIG. 5 is a schematic illustration of another example implementation of the UV lamp system of FIG. 3, in accordance with some embodiments of the technology described herein.

FIGS. 6A-6C illustrate plots of example signal waveforms for controlling operation of the UV lamp system of FIGS. 2B, 3, 4, and/or 5, in accordance with some embodiments of the technology described herein.

FIG. 7 is a flowchart representative of an example process that may be performed and/or example machine-readable instructions that may be executed by processor circuitry to implement the UV lamp system of FIGS. 2B, 3, 4, and/or 5 for UV light generation, in accordance with some embodiments of the technology described herein.

FIG. 8 is an example electronic platform structured to execute the machine-readable instructions of FIG. 7 to implement the UV lamp system of FIGS. 2B, 3, 4, and/or 5, in accordance with some embodiments of the technology described herein.

### DETAILED DESCRIPTION

The present disclosure relates generally to lamp systems arranged to produce light by conversion of electromagnetic energy into photonic radiation using ionized gases/plasmas as conversion media. More particularly, the present disclosure pertains to the production of ultraviolet (UV) radiation by conversion of energy of microwave radiation produced by separate sources of microwave electromagnetic fields and delivered to ionize and ignite discharges in desired bulb fill compositions and mixtures.

In some embodiments, UV radiation encompasses light exhibiting wavelengths not exceeding 550 nanometers (nm). Thus, even though a segment of the spectrum of lights used in substance treatments and modifications can be detected by human eyes, it may be considered as a part of the UV spectrum (also commonly known as ultraviolet-visible or UVV spectrum) on the basis of predominant functionality in substance processing, rather than visual detection, recording, and/or observation.

Sources of UV radiation have been exploited in a variety of commercial and personal uses, utilizing abilities of sufficiently energetic UV photons having energies between 3 electron volts (eV) and 12 eV generally characteristic for the UV spectral ranges. Such photons have been used for material processing based upon implementation or alteration of physicochemical processes resulting either in weakening or elimination of physicochemical bounds between constituent ingredients (e.g., in processes of photodissociation, surface cleaning, photodissociation, disinfection, etc.) or inducing creation of new and/or augmentation of preexisting physicochemical bounds. Example physicochemical processes include photopolymerization, surfaces bindings and adhesion, surface cleaning (e.g., by impurity oxidation and removal), and/or drying and solvents removal.

Some UV lamp systems generate UV radiation by using electronic microwave tubes (e.g., magnetrons). Some such systems incorporate electrodeless light sources arranged to radiate UV light from electrodeless plasma generated by direct action of microwave (MW) fields generated by magnetrons on media encapsulated into transparent or translucent dielectric envelopes having no internal electrodes and/or antennas. For example, high power (e.g., in order of 1 kilowatt (kW) or more) UV electrodeless gas-discharge light sources may incorporate magnetrons for generation and amplification of RF radiation used to create and sustain UV-producing plasmas. Some such electrodeless light sources are customarily arranged within a sufficiently conductive MW cavity or chamber, or positioned in proximity of an external antenna, such that near field MW radiation can penetrate the dielectric envelope. The magnetrons are sources of MW radiation that can be powered to generate microwaves and arranged to be coupled via radiofrequency/microwave (RF/MW) conduits to the electrodeless light sources.

Constituents of the plasma (e.g., atoms, ions, molecules, excimers, radicals, clusters and mixtures and combinations of such), exited by the RF/MW fields (either directly or by interactions with fields-generated electrons and photons) radiatively transition to lower energy states by emitting UV photons exhibiting frequencies having characteristic spectral distributions. Such photons may further interact with plasma, volumes of surrounding neutral gas, layered media adsorbed on envelope internal and external surfaces, and surrounding media, to be eventually redirected to irradiate substrates and surfaces undergoing treatments.

Some electrodeless light sources are UV gas-discharge light sources that include transparent axially-symmetric (e.g., elongated) tubular envelopes of synthetic or naturally-generated fused silica. The envelopes can be filled with bulb fills incorporating gas mixtures generally based on noble gases, and may further include additional vapors of liquid (e.g., mercury) and/or condensed (e.g., solid or liquid) additives.

Examples of additives include halides of metals, metalloids, transitional elements, and nonmetals. Examples of some less-common additives include precursors for molecular and/or cluster emitters exemplified by sulfur or selenium. The above variety of additives, customarily introduced in variable quantities and mixtures of variable proportions, mandates great attention to the design, optimization, and controllability of associated MW generators in order to achieve desired energy conversion resulting in radiant, stable, controllable, and lasting sources of UV photons.

Some UV lamp systems generate UV radiation by using solid-state generators. For example, some such UV lamp systems may use solid-state RF/MW generators and amplifiers for plasma generation and sustainment for application in the field of plasma processing.

UV lamp systems incorporating electrodeless light sources typically utilize magnetron-based RF/MW sources over solid-state sources. Such a preference for magnetrons may be understood, at least in part, on the base of features pertinent to relative complexity and excessive size of solid-state generators/amplifiers in up to 5 kW/5 gigahertz (GHz) power/frequency ranges with respect to magnetrons. It has been recognized that efficiency of solid-state-based RF/MW sources were previously competitive compared with magnetrons only in applications exhibiting careful input power control, strict temperature regulation, and by using of quality electronic elements and systems providing necessary stability and linearity. However, it has been recognized that the efficiency of solid-state-based RF/MW sources has improved compared to magnetrons and affords numerous advantages as discussed in further detail herein.

Embodiments disclosed herein include systems, apparatus, and methods for ultraviolet (UV) radiation generation at least in part using solid-state amplifiers. UV radiation embodiments disclosed herein can ignite bulb fills capable of emitting light in the UV and/or UVV spectrum with improved controllability and efficiency and reduced size compared to magnetron-based UV lamp systems.

Some embodiments include a microwave cavity comprising an electrodeless UV bulb, and the electrodeless UV bulb comprising a bulb fill capable of emitting UV light. Beneficially, by leveraging the improved controllability and efficiency of solid-state amplifiers, the techniques and embodiments disclosed herein are applicable to a wide range of electrodeless light sources, such as electrodeless UV bulbs. For example, the electrodeless light sources can be UV gas-discharge light sources that include transparent axially-symmetric (e.g., elongated) tubular envelopes of synthetic or naturally-generated fused silica. The techniques and embodiments can be applicable to envelopes filled with bulb fills incorporating gas mixtures generally based on noble gases and may further include additional vapors of liquid (e.g., mercury) and/or condensed (e.g., solid or liquid) additives.

Some embodiments include at least one synthesizer (e.g., a mixer, an oscillator) configured to generate a microwave signal. For example, the at least one synthesizer can be configured to receive a control signal (e.g., from controller(s), programmable processor(s), etc.) and modulate the control signal using one or more modulation techniques (e.g., amplitude modulation, frequency modulation, phase modulation, etc., and/or any combination(s) thereof) to generate and/or output the microwave signal. Beneficially, the at least one synthesizer can be configured to modulate the control signal with improved speed and control granularity with respect to conventional magnetron-based UV lamp systems.

Some embodiments include at least one solid-state amplifier configured to amplify the microwave signal to generate an amplified microwave signal for igniting the bulb fill to emit UV light. Beneficially, the at least one solid-state amplifier can be configured to amplify the microwave signal with improved efficiency and control granularity with respect to conventional magnetron-based UV lamp systems.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

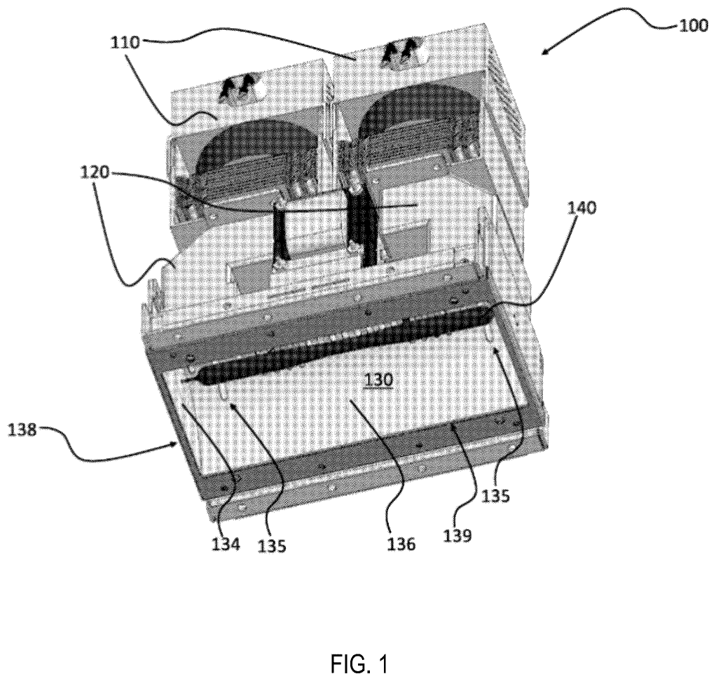

Turning to the figures, the illustrated example of FIG. 1 is an example ultraviolet (UV) lamp system 100. For enhanced clarity and improved presentation, only the principal subsystems of the UV lamp system 100 are illustrated in FIG. 1 and auxiliary components (e.g., housings, handles, conductors and conduits, cooling ducts, etc.) have been omitted but may be included.

The UV lamp system 100 is an optical system (e.g., an irradiator) that incorporates radiofrequency (RF) and/or microwave (MW) sources in the form of one or more magnetrons 110, coupled to one or more RF/MW conduits 120. Examples of the RF/MW conduits include cables (e.g., RF/MW cables), transmission lines (e.g., RF/MW transmission lines), waveguides, striplines (e.g., RF/MW striplines), and combination(s) thereof.

As shown, the RF/MW conduits 120 are arranged to match an RF/MW cavity 130 extending electromagnetic fields from the magnetrons 110 into the cavity 130 via one or more matching slots 135. The one or more matching slots 135 are RF slots. The cavity 130 is bounded by reflecting surfaces 134, 136, which include side surfaces 134 and a back surface 136, arranged to redirect UV radiation outward through a light-transmitting window 138 incorporating conductive mesh 139. The UV lamp system 100 may include an optical reflector separated from the surfaces 134, 136. The surfaces 134, 136 and the mesh 139, simultaneously, function as conductive walls of the cavity 130 arranged to prevent losses of the RF/MW energy to the outside volumes and the UV lamp system 100 is arranged to redirect the UV light onto desired treatment targets.

The RF/MW fields in the cavity 130 surround and penetrate an electrodeless UV bulb 140 arranged to contain RF-generated plasma energized to emit UV radiation. The electrodeless UV bulb 140, when ignited, acts as a load for the RF/MW sources 110 dissipating the RF fields energy and, at least by such action, minimizing reflected RF/MW power traveling in the direction of the magnetron 110 sources.

In some embodiments, the electrodeless UV bulb 140 has a transparent (e.g., for UV) dielectric material envelope. Examples of the dielectric material envelope include fused silica, natural or synthetic quartzes and other minerals, SiO2 and other metal, nonmetal, or metalloid oxides, salts, silicates, nitrides, carbides, and borates.

In some embodiments, one or more buffer gases, one or more liquids, and/or one or more condensed additives are sealed in the electrodeless UV bulb 140. Examples of a buffer gas include He, Ne, Ar, Kr, Xe, Hg vapor, N₂, and mixtures and combinations thereof. An example of a liquid is a vapor of liquid, such as mercury. Examples of a condensed additive includes halides of metals, metalloids, transitional elements, nonmetals, selenium, sulfur, and combinations thereof. The metals, nonmetals, metalloids, and transitional elements can be selected from the group consisting of S, Se, Te, As, Sb, Ge, Pb, Al, Ga, In, Zn, Cd, Cu, Tl, Co, Ni, Sn, Bi, Ta, alloys, and combinations thereof.

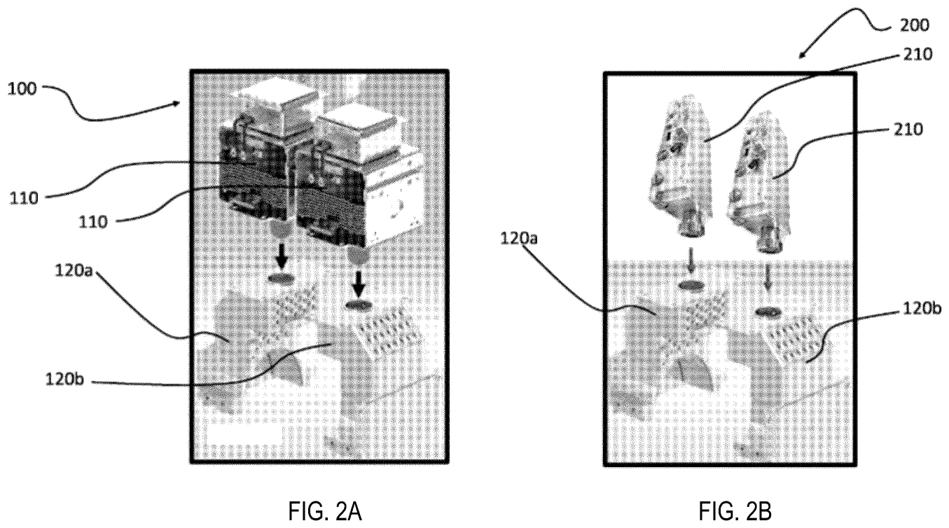

FIG. 2A illustrates an arrangement of the magnetrons 110 and the RF/MW conduits 120 of the UV lamp system 100 of FIG. 1. As shown, the magnetrons 110 are respectively coupled to RF/MW conduits 120a and 120b.

FIG. 2B illustrates another example UV lamp system 200 having benefits over the UV lamp system 100 of FIGS. 1 and/or 2A. The UV lamp system 200 of FIG. 2B includes an arrangement of amplifiers 210 and the RF/MW conduits 120 of FIGS. 1 and/or 2A (shown as RF/MW conduits 120a and 120b in FIG. 2B).

The amplifiers 210 of this example are solid-state amplifier modules that may respectively include one or more solid-state amplifiers. As shown, the UV lamp system 200 of FIG. 2B has the benefit of being physically smaller than the UV lamp system 100 of FIG. 2A because of the amplifiers 210 being smaller sized than the size of the magnetrons 110.

In some embodiments, the amplifiers 210 require efficient coupling of the amplified RF/MW energy into the RF/MW conduits 120a, 120b in order to supply sufficient energy to sustain discharges and prevent potentially damaging back-reflections of RF/MW energy into connected amplifier stages.

In some embodiments, the amplifiers 210 enable generation of RF/MW fields having field energies to transfer RF/MW power of interest to an electrodeless bulb in a microwave cavity via the RF/MW conduits 120a, 120b. In some such embodiments, the amplifiers 210 can generate RF/MW fields exhibiting output power of 100 Watts (W) and above. Examples of output power can be 100 W, 200 W, 300 W, 400 W, 500 W, 1000 W (1 kW), 2000 W (2 kW), 3000 W (3 KW), etc. Examples of output power can be expressed in ranges, such as output power in a range from 0-100 W, 0-200 W, 0-300 W, 0-400 W, 0-500 W, 0-1000 W, 0-2000 W, 0-3000 W, etc.

In some embodiments, the amplifiers 210 can generate RF/MW fields having frequencies in the industrial, scientific, and medical (IMS) radio frequency range of 400 megahertz (MHZ) to 3.5 GHz. For example, the amplifiers 210 can generate RF/MW fields having frequencies in a range from 2.4 GHz to 2.5 GHz to drive UV bulbs (e.g., UV electrodeless bulbs). In another example, the amplifiers 210 can generate RF/MW fields having frequencies in a range from 2.3 GHZ to 2.6 GHz to drive UV bulbs (e.g., UV electrodeless bulbs).

In some embodiments, the amplifiers 210 can be combined to form composite amplifier packages up to 10 kilowatts (kW), which in turn, can be further paralleled into amplification systems reaching several hundred kilowatts (e.g., 100 kW, 200 kW, 300 KW, 400 kW, 500 KW, etc.).

In some embodiments, the amplifiers 210 can generate RF/MW fields having frequencies in ISM frequency ranges from 433.05 MHz to 434.79 MHz and from 902 MHz to 928 MHz, where the frequency ranges of interest may allow for amplifier packages (e.g., integral amplifier packages) up to 500 kW of output power for the operating time of interest.

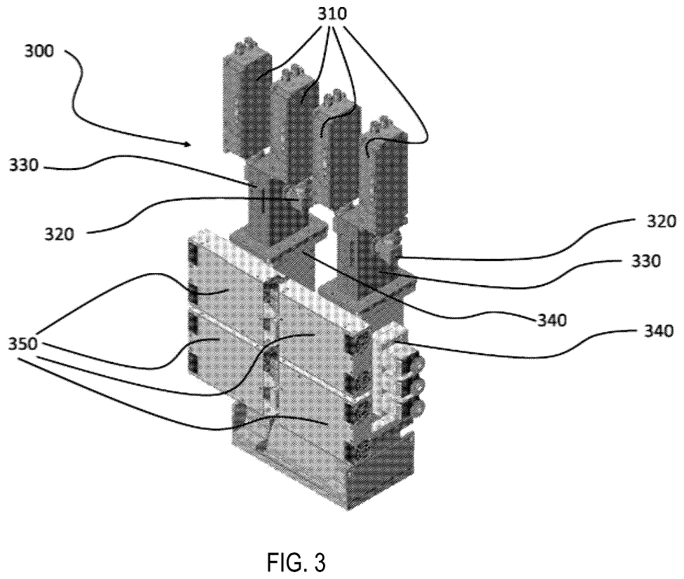

FIG. 3 illustrates an isometric view of an example UV lamp system 300 including a plurality of amplifiers 310. Although not shown, the UV lamp system 300 includes other UV lamp system components. Examples of such other UV lamp system components include the RF/MW conduits 120, the cavity 130, the reflecting surfaces 134, 136, the slots 135, the light-transmitting window 138, the conductive mesh 139, and the electrodeless UV bulb 140 of FIG. 1.

The amplifiers 310 of this example are solid-state amplifier modules that may respectively include one or more solid-state amplifiers. In some embodiments, the amplifiers 310 may correspond to and/or implement the amplifiers 210 of FIG. 2B.

As shown, there are four amplifiers 310. For example, the four amplifiers 310 may each include at least one solid-state amplifier. Alternatively, fewer or more than four of the amplifiers 310 may be used.

The amplifiers 310 are conductively connected to power couplers 320. The power couplers 320 are RF/MW power coupling modules that, when driven by the amplifiers 310, transfer RF/MW energy from the amplifiers 310 to one or more power combiners 330.

The power combiners 330 of the illustrated example are arranged to connect to waveguide flanges of one or more tuners 340, which are 3-stab tuners in this example. For example, one of the power combiners 330 can combine the outputs from a set of amplifiers (e.g., a set of two amplifiers 310 shown in FIG. 3) into a combined output, which is provided to one of the tuners 340. The tuners 340 can be configured to control an amount of the output from the power combiners 330 provided to the RF/MW cavity 130 via the RF/MW conduits 120a, 120b. Examples of the waveguide flanges include WR340 waveguide flanges.

In the illustrated example, the tuners 340 are coupled to the RF/MW cavity 130, which contains and/or otherwise includes the UV bulb 140 of FIG. 1, using waveguide sections conductively connected to form the RF/MW conduit 120. The waveguide sections may be short WR340 waveguide sections.

In the illustrated example, synthesizers 350 provide input signals (e.g., control signals, command signals, drive signals) to the amplifiers 310. The synthesizers 350 are electronic devices configured to modulate an input signal. Examples of the synthesizers 350 include mixers and oscillators.

The synthesizers 350 can be configured to receive a control signal (e.g., from controller(s), programmable processor(s), etc.) and modulate the control signal using one or more modulation techniques (e.g., amplitude modulation, frequency modulation, phase modulation, etc., and/or any combination(s) thereof) to generate and/or output a modulated signal. The modulated signals can be used to control the amplifiers 310.

In some embodiments, one(s) of the synthesizers 350 are preprogrammed. For example, one or more parameters and/or characteristics associated with the amplified RF/MW fields coupled via the power couplers 320 can be fully programable by users to achieve desired operation of the UV lamp system 300. In such an example, the synthesizers 350 can be configured and/or programmed to adjust, change, and/or modify one or more of the parameters and/or characteristics.

Examples of the parameters and/or characteristics include intensity, phase, frequency, and on/off timing (e.g., duty cycle) of the amplified RF/MW fields. For example, one(s) of the synthesizers 350 can be configured and/or programmed to adjust, change, and/or modify an intensity of the output from the amplifiers 310 with respect to time.

In some embodiments, one(s) of the synthesizers 350 is/are adaptively and/or dynamically controlled. For example, one or more parameters and/or characteristics associated with the amplified RF/MW fields coupled via the power couplers 320 can be adjusted, changed, modified, etc., in nearly real time to achieve desired operation of the UV lamp system 300.

As used herein “real time”, “nearly real time,” “substantially real time”, and “substantially real-time” refer to occurrence in a near instantaneous manner recognizing there may be real-world delays for computing time, transmission, etc. Thus, unless otherwise specified, “real time”, “nearly real time,” “substantially real time”, and “substantially real-time” refer to being within a 1-second time frame, a 0.5-second time frame, a 250-millisecond time frame, a 100-millisecond time frame, a 10-millisecond time frame, etc., of real time. For example, an event described herein occurring in “real time”, “nearly real time,” “substantially real time”, and “substantially real-time” is occurring within 1 second, within 0.5 seconds, within 250 milliseconds, within 100 milliseconds, within 10 milliseconds, etc., of real time.

In some embodiments, each of the synthesizers 350 may control a corresponding one of the amplifiers 310. For example, dedicating a synthesizer 350 for each amplifier 310 may enable flexibility of independent control of the amplifiers 310. As shown, there are four synthesizers 350 and each synthesizer may control one of the four amplifiers 310.

In some embodiments, one of the synthesizers 350 may control multiple ones of the amplifiers 310. For example, a synthesizer 350 may have multiple outputs with each output coupled to one of the amplifiers 310.

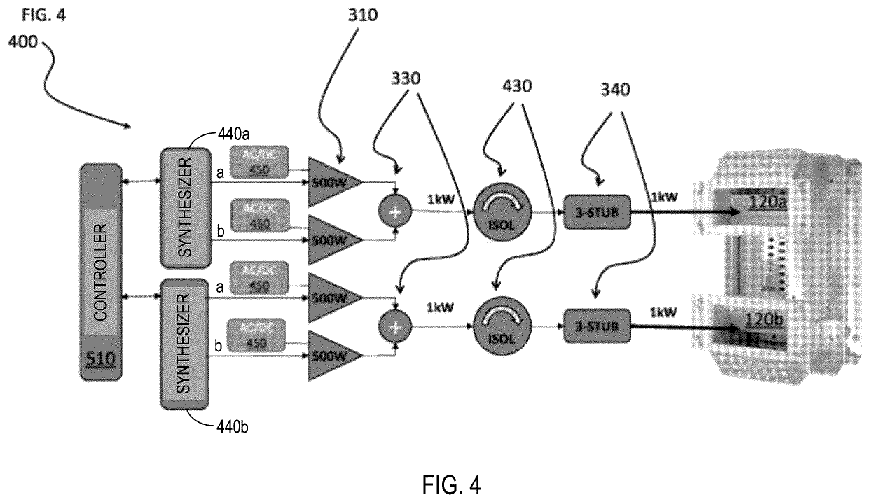

FIG. 4 is a schematic illustration of another example UV lamp system 400. Although not shown, the UV lamp system 300 includes other UV lamp system components. Examples of such other UV lamp system components include the cavity 130, the reflecting surfaces 134, 136, the slots 135, the light-transmitting window 138, the conductive mesh 139, and the electrodeless UV bulb 140 of FIG. 1.

In some embodiments, the UV lamp system 400 is an example implementation of the UV lamp system 200 of FIG. 2B and/or the UV lamp system 300 of FIG. 3. In the illustrated example, the RF/MW conduits 120a, 120b of FIG. 4 are insulated from the amplifiers 310 by at least one circulator 430.

In the illustrated example, the UV lamp system 400 incorporates synthesizers 440a, 440b arranged to generate initial microwave signals adjustable to cover at least the ISM band of frequencies (e.g., frequencies nominally centered on 2.45 GHZ) exhibiting external controllability of at least +/−10 MHZ.

As shown, the UV lamp system 400 may incorporate and/or otherwise include controller 510. Output(s) of the controller 510 is/are coupled to input(s) of the synthesizers 440a, 440b such that the controller 510 can control operation of the synthesizers 440a, 440b. Configuration and/or operation the controller 510 is discussed further below.

In some embodiments, the synthesizers 440a, 440b may be arranged to generate custom initial microwave signals' harmonic waveforms or the waveforms different from harmonic oscillations. More specifically, at least some of the initial waveforms may be individually programmed for temporal (e.g., periodic or randomized) frequency variations (e.g., frequencies swiping over a portion or the entire 2.45 GHz and/or other ISM bands).

In some embodiments, the amplitudes of the initial microwave signals may be preprogramed to vary at least on the microsecond time scale. The above changes may be optimized for different types of the bulb 140, different applications (e.g., photochemical processes), and/or different power levels.

As shown, output(s) of the synthesizers 440a, 440b is/are coupled to input(s) of the amplifiers 310. For example, at least one output of synthesizer 440a is coupled to at least one input of one of the amplifiers 310.

The synthesizers 440a, 440b have multiple output channels. As shown, synthesizer 440a has two channels (e.g., channels “a” and “b”) with a first channel “a” coupled to an input of a first one of the amplifiers 310 and a second channel “b” coupled to an input of a second one of the amplifiers 310. Also as shown, synthesizer 440b has two channels (e.g., channels “a” and “b”) with a first channel “a” coupled to an input of a third one of the amplifiers 310 and a second channel “b” coupled to an input of a fourth one of the amplifiers 310.

As shown, one or more alternating current-to-direct current (AC/DC) converters 450 may be utilized to provide sufficient DC power (e.g., 10-100 Volts (V) DC) for the amplifiers 310. For example, at least one output of one of the AC/DC converters 450 is coupled to at least one input of one of the amplifiers 310. The amplifiers 310 are shown as 500 W amplifiers. Alternatively, one(s) of the amplifiers 310 may be configured to provide a different power output (e.g., 100 W, 1 kW).

As shown, outputs of the amplifiers 310 are coupled to the power combiners 330. For example, at least one output of a first one of the amplifiers 310 and at least one output of a second one of the amplifiers 310 are coupled to respective inputs of one of the power combiners 330. Furthering the example, when the amplifiers 310 are 500 W amplifiers, the power combiners 330 can combine the outputs from two of the 500 W amplifiers 310 to generate a combined output up to 1 kW. Further, as shown, outputs of the power combiners 330 are coupled to the circulators 430, which are in turn coupled to the tuners 340.

In some embodiments, each of the amplifiers 310 can be independently controlled and provided with the independent initial microwave signals (e.g., from separate synthesizers 440a, 440b) at the amplifiers' inputs. In some such embodiments, common phase delays may be maintained for the amplified signals to be combined in the individual combiners 330 to avoid signal interferences-related variations and instabilities in the reflected and forward-propagating microwave fields and patterns.

The UV lamp system 400 has benefits over magnetron-based lamp systems, such as the UV lamp system 100 of FIGS. 1 and/or 2A. One such benefit includes faster control and control over a wider range of UV lamp parameters. For example, only the currents (and therefore, output powers) of the magnetrons 110 can be effectively modified on the fraction of a second time scale, whereas, in the UV lamp system 400, substantially all operating parameters of the amplifiers 310 (and thus, the microwave energy coupled to the plasma in the UV bulb 140) are conducive to control on the microsecond time scale.

For example, the driving microwave input from the first synthesizer 440a can be shifted in frequency (Δf) with respect to such of the second synthesizer 440b (e.g., Δf ranging from 10 Hz to 100 MHZ) to create interference beat patterns (e.g., interference beating patterns). Various interference beat patterns exhibit nonuniform and time-dependent MW/RF fields' distributions inside the microwave cavity 130, characterized by complex patterns of high (e.g., above average) and low (e.g., below average) fields intensities that effectively, in time, sample the entire volumes of bulbs 140. Before the ignition of the plasma, it is likely that at least at the high fields locations, avalanche ionization of the bulb fill will occur providing sufficient electron population to support substantially instant bulb fill breakdown through the entire bulb.

In some embodiments, interference beating patterns in the plasma can readily contribute to mixing of plasma constituents. Such mixing has positive effects resulting in more uniform UV bulb radiances and, consequently, reduced thermal gradients in bulb envelopes along the bulb 140 longitudinal axis. Overall benefits in UV systems stability, longevity, and applications' processes controllability have been also demonstrated.

Furthermore, power delivered to RF/MW conduits 120a and 120b can be substantially instantly varied (e.g., from 0% to 200% of nominal power of “nominal operation”) as desirable, for example, to achieve improvements on at least one of bulb ignition processes, bulb thermal condition, or overall process efficiencies.

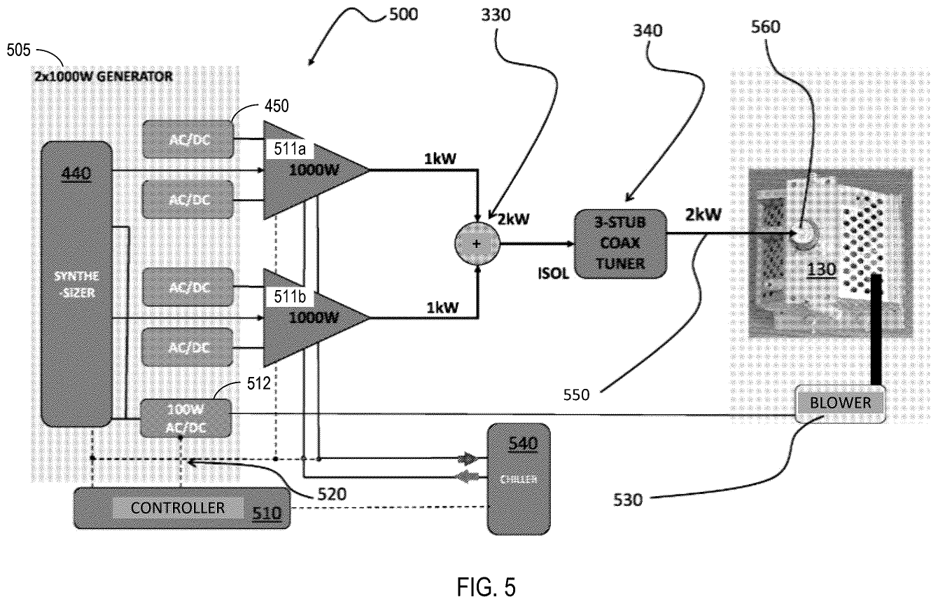

FIG. 5 is a schematic illustration of yet another example UV lamp system 500. In some embodiments, the UV lamp system 500 is an example implementation of the UV lamp system 300 of FIG. 3 and/or the UV lamp system 400 of FIG. 4. Although not shown, the UV lamp system 300 includes other UV lamp system components. Examples of such other UV lamp system components include the RF/MW conduits 120, the cavity 130, the reflecting surfaces 134, 136, the slots 135, the light-transmitting window 138, the conductive mesh 139, and the electrodeless UV bulb 140 of FIG. 1.

The UV lamp system 500 of this example includes a generator 505. The generator 505 can be an RF and/or MW generator. For example, the generator 505 can generate electrical signals having frequencies in the RF and/or MW frequency ranges. The generator 505 is a 2×1000 W generator such that output from the generator 505 can be used to effectuate a power output up to at least 2000 W. Alternatively, the generator 505 may be configured to effectuate a different power output or comprise a different number of signal channels (e.g., a 4×500 W generator, an 8×250 W generator, etc.).

The generator 505 includes a synthesizer 440. In some embodiments, the synthesizer 440 is a single synthesizer with multiple outputs. In some embodiments, the synthesizer 440 includes and/or implements multiple synthesizers with each synthesizer having at least one output. In some such embodiments, the synthesizer 440 can include and/or implement the synthesizers 440a, 440b of FIG. 4.

The synthesizer 440 has multiple outputs including a first output coupled to an input of a first amplifier 511a, a second output coupled to an input of a second amplifier 511b, and a third output coupled to an input of an AC/DC converter 512. The AC/DC converter 512 is a 100 W AC/DC converter, which provides DC power to a blower 530. Alternatively, the AC/DC converter 512 may have a different power output, such as 50 W, 150 W, etc.

The amplifiers 511a, 511b of this example are solid-state amplifier modules each including one or more solid-state amplifiers. For example, the amplifiers 511a, 511b can correspond to the amplifiers 210 of FIG. 2B, the amplifiers 310 of FIG. 3, and/or the amplifiers 310 of FIG. 4. The amplifiers 511a, 511b of this example are 1000 W solid-state amplifiers such that they are respectively configured to amplify an input to have a power output up to at least 1000 W.

Outputs of the amplifiers 511a, 511b are shown to be coupled to inputs of the power combiner 330 of FIGS. 3 and/or 4. The power combiner 330 of this example is configured to combine two power channels into a single power output. Each of the two power channels of this example can have a power output up to at least 1 kW. The single power output of this example is a power output up to at least 2 kW. The above values are examples and other power values can be used in connection with the UV lamp system 500.

Output(s) of the power combiner 330 is/are coupled to input(s) of the tuner 340 of FIGS. 3 and/or 4. In some embodiments, the power combiner 330 is coupled to the tuner 340 via the circulator 430 of FIG. 4. Output(s) of the tuner 340 is/are coupled to input(s) of an RF/MW cavity, such as the RF/MW cavity 130 of FIG. 1.

In the illustrated example, the UV lamp system 500 includes controller 510 configured to control functionality of the UV lamp system 500. The controller 510 may be connected to the functional subsystems of the UV lamp system 500 using conductive or radiative connections to communication channels 520 arranged for transmission of control data and/or reception of feedback information.

In some embodiments, the controller 510 is implemented by distinct control elements and subsystems (e.g., based upon programmable processors, smart sensors, etc.) or integral or separate computers programed to execute predetermined functions and protocols.

In some embodiments, the controller 510 is implemented by one or more programmable processors. Examples of programmable processors include central processing units (CPUs), digital signal processors (DSPs), field programmable gate arrays (FPGAs), artificial intelligence processors (e.g., neural network processors), and graphics processing units (GPUs). For example, the controller 510 can be implemented by one or more CPUS, each of which may include one or more compute cores.

The UV lamp system 500 also incorporates separate cooling subsystems including the blower 530 arranged to cool the microwave bulb 140 (not shown), and a liquid-coolant-based cooling system incorporating at least one chiller 540. The at least one chiller 540 can be arranged to remove heat from the amplifiers 511a, 511b. Beneficially, such arrangements offer additional flexibilities to precisely and efficiently control temperatures of the critical components of the UV lamp system 500, utilizing, for example, integrated functionalities of the controller 510.

In the illustrated example, the UV lamp system 500 is implemented with coaxial couplings from the amplifiers 511a, 511b to the cavity 130 using coaxial cables 550 terminated into purposely designed coaxial launcher 560. Alternatively, the coaxial couplings may be implemented using a different RF/MW conduit. Beneficially, such flexible coaxial coupling allows for additional flexibilities in physical arrangements of microwave-generating subsystems (e.g., synthesizers, amplifiers, combiners, chillers, etc.) and UV-generating subsystems (cavities, bulbs, blowers, etc.).

In some embodiments, the tuners 340 may be omitted (e.g., once the optimization of the microwave subitems have been achieved) and replaced, for example, by the predetermined lengths of waveguides or coaxial cables carefully constructed to reproduce phases and microwave fields patterns as prearranged (optimized) by the use of full adjustability of the tuners 340. For example, the UV lamp system 300 of FIG. 3, the UV lamp system 400 of FIG. 4, and/or the UV lamp system 500 may not include the tuners 340. In another example, the UV lamp system 300 of FIG. 3, the UV lamp system 400 of FIG. 4, and/or the UV lamp system 500 may include the tuners 340.

In some embodiments, the controller 510 may be configured and/or programmed to time-modulate the amplitudes of signals delivered to the amplifiers 511a, 511b and/or the amplification ratio of the amplifiers 511a, 511b to effectuate the desired effects during the operation of the UV lamp system 500.

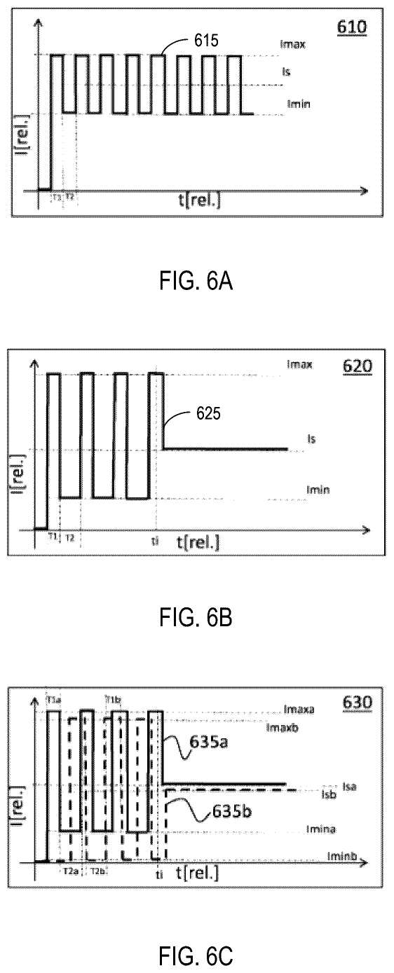

In some embodiments, amplitudes of RF/MW field structures in the cavities 130 can be dynamically changed at least by (i) modulation, by the synthesizer(s) 440, of the initial MW signal delivered to the amplifier(s) 511a, 511b and/or (ii) modulation, by the synthesizer(s) 440, of the amplification ratio in accordance with at least one control signal (e.g., from the controller 510). Such signals represent input signals relative to the amplifiers 511a, 511b and may be referred to herein as “modulated input signals”. The modulated input signals may be characterized by the plots 610, 620, 630 shown in FIGS. 6A-6C.

By way of example, the controller 510 can generate and/or output a first signal to the synthesizer(s) 440. The first signal can be a first control signal (e.g., a first input control signal) to adjust, change, and/or modify how the synthesizer(s) 440 modulate an RF/MW signal for output to the amplifiers 511a, 511b. For example, in response to the first signal, the synthesizer(s) 440 can modulate an RF/MW signal into a modulated RF/MW signal for output to the amplifiers 511a, 511b for amplification in accordance with an amplification ratio. Additionally and/or alternatively, the controller 510 can generate and/or output a second signal to one(s) of the amplifiers 511a, 511b. The second signal can be a second control signal (e.g., a second input control signal) to adjust, change, and/or modify an amplification ratio of the one(s) of the amplifiers 511a, 511b. Furthering the example, the amplifiers 511a, 511b can amplify the modulated RF/MW signal to generate an amplified RF/MW signal, which is delivered to the UV electrodeless bulb 140 for igniting the bulb fill to emit UV light.

While example implementations of UV lamp systems 200, 300, 400, 500 are depicted in FIGS. 2B-5, other implementations are contemplated. For example, one or more blocks, components, functions, etc., of the UV lamp system 200 of FIG. 2B, the UV lamp system 300 of FIG. 3, the UV lamp system 400 of FIG. 4, and/or the UV lamp system 500 of FIG. 5 may be combined or divided in any other way. The UV lamp system 200 of FIG. 2B, the UV lamp system 300 of FIG. 3, the UV lamp system 400 of FIG. 4, and/or the UV lamp system 500 of FIG. 5 may be implemented by hardware alone, or by a combination of hardware, software, and/or firmware. For example, the UV lamp system 200 of FIG. 2B, the UV lamp system 300 of FIG. 3, the UV lamp system 400 of FIG. 4, and/or the UV lamp system 500 of FIG. 5 may be implemented by one or more analog circuits (e.g., capacitors, comparators, diodes, inductors, operational amplifiers, resistors, transistors, etc.), one or more digital circuits (e.g., logic gates, etc.), one or more hardware-implemented state machines, one or more programmable processors, one or more application specific integrated circuits (ASICs), etc., and/or any combination(s) thereof.

FIGS. 6A-6C illustrate plots 610, 620, 630 of example waveforms 615, 625, 635a, 635b for controlling operation of the UV lamp system 200, 300, 400, 500 of FIGS. 2B, 3, 4, and/or 5. For example, the amplifiers 210 of FIG. 2B, the amplifiers 310 of FIGS. 3 and/or 4, and/or the amplifiers 511a, 511b of FIG. 5 can generate amplified RF/MW output signals having the waveforms 615, 625, 635a, 635b. Plots 610, 620, 630 respectively have an x-axis of time and a y-axis of relative electrical current.

FIG. 6A shows plot 610 of a waveform 615 having a modulation pattern characterized by synchronous modulation of the input signals to the amplifiers 210, 310, 511a, 511b powering common RF/MW conduit 550 or synchronously powering both RF/MW conduits 120a and 120b. The modulations of both channels “a” and “b” may be achieved by driving the amplifiers 210, 310, 511a, 511b above a set amplitude (identified by “Is”) to a predetermined upper level (identified by “Imax”) for a first time duration (or a period in the case of periodic modulations) (identified by “T1”) and subsequently reducing the amplitude to a predetermined lower level (identified by “Imin”) for a second time duration (identified by “T2”).

The predetermined upper level is a first threshold (e.g., a first amplitude threshold) and the predetermined lower level is a second threshold (e.g., a second amplitude threshold). As shown in FIG. 6A, the controller 510 may drive the amplifiers 210, 310, 511a, 511b to adjust the amplitude of the amplified microwave signal to meet or exceed the first amplitude threshold for the first time period T1. As shown in FIG. 6A, the controller 510 may drive the amplifiers 210, 310, 511a, 511b to adjust the amplitude of the amplified microwave signal to meet or fall below the second amplitude threshold for the second time period T2.

In some embodiments, the time durations (e.g., T1 and T2) and/or the levels (e.g., Imax, Is, Imin) can be independently optimized for the desirable plasma and operation regimes of the UV lamp system 200, 300, 400, 500. The optimization may be performed over broad parameter spaces, of which bulb temperatures and spectral radiances variables may be of particular interest. Beneficially, it is significant that the solid-state amplifiers 210, 310, 511a, 511b can be modulated during periods (e.g., during T1 and/or T2) much shorter than characteristic times governing plasma processes in the different bulbs resulting in substantially uniform, isotropic, and constant UV radiances.

FIG. 6B shows plot 620 of a waveform 625 that pertains to embodiments having modulation patterns arranged for efficient bulbs' ignition. For example, the bulbs incorporating additives may require higher microwave field intensities (e.g., Imax) exuding such intensities used for periods of standard bulb operations (e.g., Is). In some such embodiments, the amplifiers 210, 310, 511a, 511b can be configured and/or programmed to provide “overpowered” output levels (e.g., Imax) for multiple time periods T1, while being allowed to cool down during reduced power (e.g., Imin) for multiple time periods T2. Such operations may be repeated (e.g., iteratively repeated) until the bulb ignition has been detected at a nominal ignition time (identified by “ti”). After the ignition time ti, the amplification ratios have been programmed to reduce to the standard (e.g., desired) settings (identified by “Is”).

FIG. 6C shows plot 630 of waveforms 635a, 635b that pertains to embodiments (e.g., the UV lamp system 400 of FIG. 4) having more than one input (e.g., RF/MW conduits 120a and 120b) for RF/MW energy into the cavity 130. In some such embodiments, the different modulation patterns of the waveforms 635a and 635b may be optimized for effective ignition of the bulbs. As discussed above in connection with FIG. 6B, the amplifiers 210, 310, 511a, 511b can be independently driven into the “overpower” operation for distinct time periods T1a and T1b and subsequently allowed to cool down during time periods T2a and T2b. Power levels Imaxa, Imina, and Isa for waveform 635a and Imaxb, Iminb, and Isb for waveform 635b may be varied as independent variables over the common parameter space of the system operation.

The above ignition techniques are applicable to bulbs containing buffer gasses having pressures comparable to that of medium and high-pressure mercury and mercury—metal halides bulbs. For example, bulbs comprising 1500 Torr of Ar can be successfully ignited using the ignition techniques discussed above in connection with FIGS. 6A-6C. In another example, excimer bulbs comprising up to 200 Torr of halogens (e.g., in the form of Cl2 gas) and/or additives capable of generating negative ions (including but not limited to: S, Se, Te, As, Sb, Ge, Pb, Al, Ga, In, Zn, Cd, Cu, Tl, Co, Ni, Sn, Bi, Ta, alloys and combinations) can be ignited at least to the pressures of buffer gases in order of 1000 Torr using the ignition techniques discussed above in connection with FIGS. 6A-6C.

Embodiments disclosed herein can be beneficially applicable to vertical or slanted bulb orientations where gravitational actions on the additives and plasma patterns in the bulb may need asymmetric settings on the input power channels “a” and “b”.

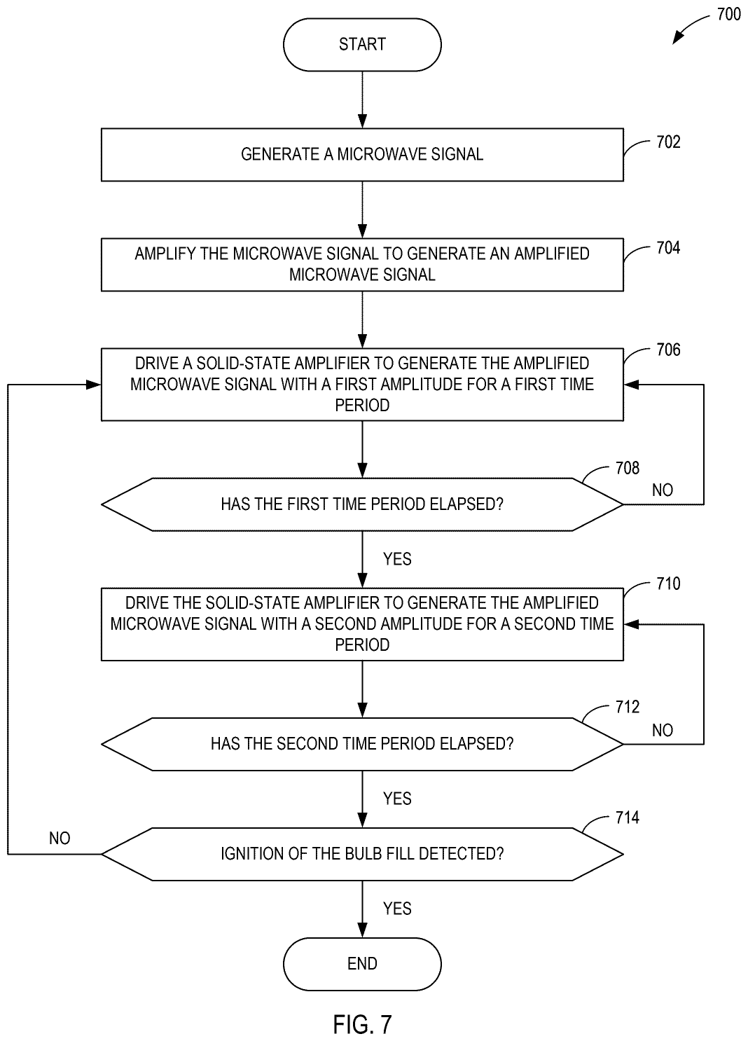

FIG. 7 is a flowchart 700 representative of an example process to be performed and/or example machine-readable instructions that may be executed by processor circuitry to implement a UV lamp system, such as the UV lamp system 200, 300, 400, 500 of FIGS. 2B, 3, 4, and/or 5, or portion(s) thereof, such as the controller 510 of FIGS. 4 and/or 5, for UV light generation. Additionally or alternatively, block(s) of the flowchart 700 of FIG. 7 may be representative of state(s) of one or more hardware-implemented state machines, algorithm(s) that may be implemented by hardware alone such as an ASIC, etc., and/or any combination(s) thereof.

The flowchart 700 of FIG. 7 begins at block 702, at which the UV lamp system 200, 300, 400, 500 of FIGS. 2B, 3, 4, and/or 5 may generate a microwave signal. For example, the synthesizer 350 of FIG. 3, the synthesizers 440a, 440b of FIG. 4, and/or the synthesizer 440 of FIG. 5 may generate a microwave signal having a microwave frequency.

At block 704, the UV lamp system 200, 300, 400, 500 may amplify the microwave signal to generate an amplified microwave signal. For example, the amplifiers 210 of FIG. 2B, the amplifiers 310 of FIGS. 3 and/or 4, and/or the amplifiers 511a, 511b of FIG. 5 may amplify the microwave signal received from the synthesizer(s) 350, 440a, 440b, 440 to generate an amplified microwave signal.

At block 706, the UV lamp system 200, 300, 400, 500 may drive a solid-state amplifier to generate the amplified microwave signal with a first amplitude for a first time period. For example, the controller 510 may generate a control signal for output to the amplifiers 210, 310, 511a, 511b. In such an example, the control signal may drive and/or otherwise cause the amplifiers 210, 310, 511a, 511b to output an amplified microwave signal having amplitude Imax shown in FIG. 6A for time period T1.

At block 708, the UV lamp system 200, 300, 400, 500 may determine whether the first time period has elapsed. For example, the controller 510 may determine that the time period T1 has not elapsed. In another example, the controller 510 may determine that the time period T1 has elapsed.

If, at block 708, the UV lamp system 200, 300, 400, 500 determines that the first time period has not elapsed, control returns to block 706 to continue driving the solid-state amplifier to generate the amplified microwave signal with the first amplitude. Otherwise, control proceeds to block 710.

At block 710, the UV lamp system 200, 300, 400, 500 may drive the solid-state amplifier to generate the amplified microwave signal with a second amplitude for a second time period. For example, the controller 510 may generate a control signal for output to the amplifiers 210, 310, 511a, 511b. In such an example, the control signal may drive and/or otherwise cause the amplifiers 210, 310, 511a, 511b to output an amplified microwave signal having amplitude Imin shown in FIG. 6A for time period T2.

At block 712, the UV lamp system 200, 300, 400, 500 may determine whether the second time period has elapsed. For example, the controller 510 may determine that the time period T2 has not elapsed. In another example, the controller 510 may determine that the time period T2 has elapsed.

If, at block 712, the UV lamp system 200, 300, 400, 500 determines that the second time period has not elapsed, control returns to block 710 to continue driving the solid-state amplifier to generate the amplified microwave signal with the second amplitude. Otherwise, control proceeds to block 714.

At block 714, the UV lamp system 200, 300, 400, 500 may determine whether ignition of the bulb fill is detected. For example, the controller 510 may determine that at least a portion of the contents (e.g., the one or more gases, the one or more liquids, and/or the one or more solid additives) in the electrodeless UV bulb 140 have ignited. In such an example, the controller 510 may determine at least one of (i) that the bulb fill has ignited, (ii) the bulb fill has been converted into a plasma, (iii) the plasma has been energized, and/or (iv) energizing of the plasma has been sustained such that UV light is emitted and/or otherwise generated.

If, at block 714, the UV lamp system 200, 300, 400, 500 determines that ignition of the bulb fill is not detected, control returns to block 706. Otherwise, the example flowchart 700 of FIG. 7 concludes.

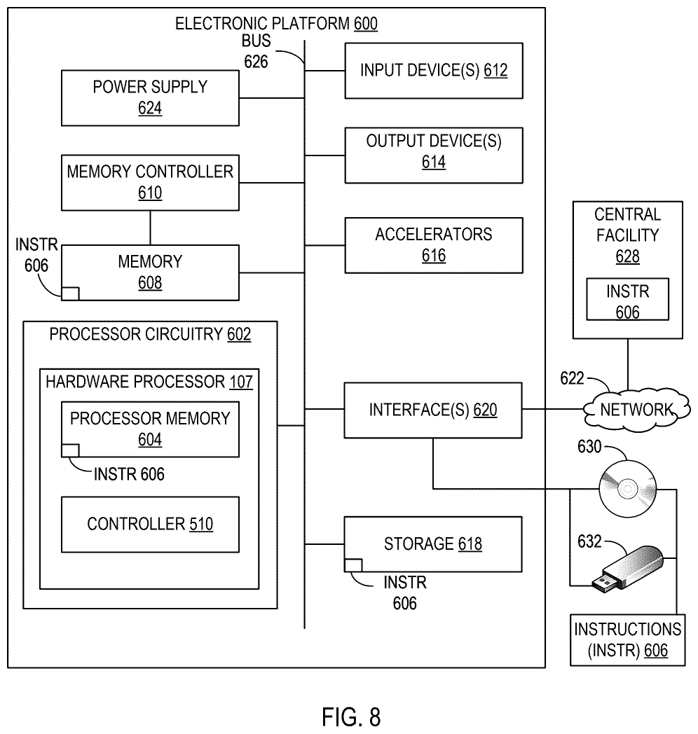

FIG. 8 is an example implementation of an electronic platform 800 structured to execute the machine-readable instructions of FIG. 7 to implement a UV lamp system, such as the UV lamp system 200, 300, 400, 500 of FIGS. 2B, 3, 4, and/or 5. It should be appreciated that FIG. 8 is intended neither to be a description of necessary components for an electronic and/or computing device to operate as a UV lamp system or for control thereof, in accordance with the techniques described herein, nor a comprehensive depiction.

The electronic platform 800 of this example may be an electronic device, such as a handset device (e.g., a cellular network device, a smartphone, etc.), a desktop computer, a laptop computer, a tablet computer, a server (e.g., a computer server, a blade server, a rack-mounted server, etc.), a workstation, or any other type of computing and/or electronic device.

The electronic platform 800 of the illustrated example includes processor circuitry 802, which may be implemented by one or more programmable processors, one or more hardware-implemented state machines, one or more ASICs, etc., and/or any combination(s) thereof. For example, the one or more programmable processors may include one or more CPUs, one or more DSPs, one or more FPGAs, one or more GPUs, etc., and/or any combination(s) thereof. The processor circuitry 802 includes processor memory 804, which may be volatile memory, such as random-access memory (RAM) of any type. The processor circuitry 802 of this example implements the controller 510 of FIGS. 4 and/or 5. In some embodiments, the processor circuitry 602 may additionally implement the synthesizers 350 of FIG. 3, the synthesizers 440a, 440b of FIG. 4, and/or the synthesizer 440 of FIG. 5.

The processor circuitry 802 may execute machine-readable instructions 806 (identified by INSTRUCTIONS), which are stored in the processor memory 804, to implement the controller 510. The machine-readable instructions 806 may include data representative of computer-executable and/or machine-executable instructions implementing techniques that operate according to the techniques described herein. For example, the machine-readable instructions 806 may include data (e.g., code, embedded software (e.g., firmware), software, etc.) representative of the flowcharts of FIG. 7, or portion(s) thereof.

The electronic platform 800 includes memory 808, which may include the instructions 806. The memory 808 of this example may be controlled by a memory controller 810. For example, the memory controller 810 may control reads, writes, and/or, more generally, access(es) to the memory 808 by other component(s) of the electronic platform 800. The memory 808 of this example may be implemented by volatile memory, non-volatile memory, etc., and/or any combination(s) thereof. For example, the volatile memory may include static random-access memory (SRAM), dynamic random-access memory (DRAM), cache memory (e.g., Level 1 (L1) cache memory, Level 2 (L2) cache memory, Level 3 (L3) cache memory, etc.), etc., and/or any combination(s) thereof. In some examples, the non-volatile memory may include Flash memory, electrically erasable programmable read-only memory (EEPROM), magnetoresistive random-access memory (MRAM), ferroelectric random-access memory (FeRAM, F-RAM, or FRAM), etc., and/or any combination(s) thereof.

The electronic platform 800 includes input device(s) 812 to enable data and/or commands to be entered into the processor circuitry 802. For example, the input device(s) 812 may include an audio sensor, a camera (e.g., a still camera, a video camera, etc.), a keyboard, a microphone, a mouse, a touchscreen, a voice recognition system, etc., and/or any combination(s) thereof.

The electronic platform 800 includes output device(s) 814 to convey, display, and/or present information to a user (e.g., a human user, a machine user, etc.). For example, the output device(s) 814 may include one or more display devices, speakers, etc. The one or more display devices may include an augmented reality (AR) and/or virtual reality (VR) display, a liquid crystal display (LCD), a light-emitting diode (LED) display, an organic light-emitting diode (OLED) display, a quantum dot (QLED) display, a thin-film transistor (TFT) LCD, a touchscreen, etc., and/or any combination(s) thereof. The output device(s) 814 can be used, among other things, to generate, launch, and/or present a user interface. For example, the user interface may be generated and/or implemented by the output device(s) 814 for visual presentation of output and speakers or other sound generating devices for audible presentation of output.

The electronic platform 800 includes accelerators 816, which are hardware devices to which the processor circuitry 802 may offload compute tasks to accelerate their processing. For example, the accelerators 816 may include artificial intelligence/machine-learning (AI/ML) processors, ASICs, FPGAs, graphics processing units (GPUs), neural network (NN) processors, systems-on-chip (SoCs), vision processing units (VPUs), etc., and/or any combination(s) thereof. In some examples, the controller 510 may be implemented by one(s) of the accelerators 816 instead of the processor circuitry 802. In some examples, the controller 510 may be executed concurrently (e.g., in parallel, substantially in parallel, etc.) by the processor circuitry 802 and the accelerators 816. For example, the processor circuitry 802 and one(s) of the accelerators 816 may execute in parallel function(s) corresponding to the controller 510.

The electronic platform 800 includes storage 818 to record and/or control access to data, such as the machine-readable instructions 806. The storage 818 may be implemented by one or more mass storage disks or devices, such as HDDs, SSDs, etc., and/or any combination(s) thereof. Examples of the data recorded by the storage 818 include data identifying different types of gasses, liquids, and/or solid additives sealed in the electrodeless UV bulb, ignition parameters for the different types of bulb fills, amplitude levels (e.g., Imax, Is, Imin, Imaxa, Imaxb, Isa, Isb, Imina, Iminb of FIGS. 6A-6C), modulation control instructions, etc.

The electronic platform 800 includes interface(s) 820 to effectuate exchange of data with external devices (e.g., computing and/or electronic devices of any kind) via a network 822. The interface(s) 820 of the illustrated example may be implemented by an interface device, such as network interface circuitry (e.g., a NIC, a smart NIC, etc.), a gateway, a router, a switch, etc., and/or any combination(s) thereof. The interface(s) 820 may implement any type of communication interface, such as BLUETOOTH®, a cellular telephone system (e.g., a 4G LTE interface, a 5G interface, a future generation 6G interface, etc.), an Ethernet interface, a near-field communication (NFC) interface, an optical disc interface (e.g., a Blu-ray disc drive, a Compact Disk (CD) drive, a Digital Versatile Disk (DVD) drive, etc.), an optical fiber interface, a satellite interface (e.g., a BLOS satellite interface, a LOS satellite interface, etc.), a Universal Serial Bus (USB) interface (e.g., USB Type-A, USB Type-B, USB TYPE-C™ or USB-C™, etc.), etc., and/or any combination(s) thereof.

The electronic platform 800 includes a power supply 824 to store energy and provide power to components of the electronic platform 800. The power supply 824 may be implemented by a power converter, such as an alternating current-to-direct-current (AC/DC) power converter, a direct current-to-direct current (DC/DC) power converter, etc., and/or any combination(s) thereof. For example, the power supply 824 may be powered by an external power source, such as an alternating current (AC) power source (e.g., an electrical grid), a direct current (DC) power source (e.g., a battery, a battery backup system, etc.), etc., and the power supply 824 may convert the AC input or the DC input into a suitable voltage for use by the electronic platform 800. In some examples, the power supply 824 may be a limited duration power source, such as a battery (e.g., a rechargeable battery such as a lithium-ion battery).

Component(s) of the electronic platform 800 may be in communication with one(s) of each other via a bus 826. For example, the bus 826 may be any type of computing and/or electrical bus, such as an I2C bus, a PCI bus, a PCIe bus, a SPI bus, a UCIe bus, and/or the like.

The network 822 may be implemented by any wired and/or wireless network(s) such as one or more cellular networks (e.g., 4G LTE cellular networks, 5G cellular networks, future generation 6G cellular networks, etc.), one or more data buses, one or more local area networks (LANs), one or more optical fiber networks, one or more private networks, one or more public networks, one or more wireless local area networks (WLANs), etc., and/or any combination(s) thereof. For example, the network 822 may be the Internet, but any other type of private and/or public network is contemplated.

The network 822 of the illustrated example facilitates communication between the interface(s) 820 and a central facility 828. The central facility 828 in this example may be an entity associated with one or more servers, such as one or more physical hardware servers and/or virtualizations of the one or more physical hardware servers. For example, the central facility 828 may be implemented by a public cloud provider, a private cloud provider, etc., and/or any combination(s) thereof. In this example, the central facility 828 may compile, generate, update, etc., the machine-readable instructions 806 and store the machine-readable instructions 806 for access (e.g., download) via the network 822. For example, the electronic platform 800 may transmit a request, via the interface(s) 820, to the central facility 828 for the machine-readable instructions 806 and receive the machine-readable instructions 806 from the central facility 828 via the network 822 in response to the request.

Additionally or alternatively, the interface(s) 820 may receive the machine-readable instructions 806 via non-transitory machine-readable storage media, such as an optical disc 830 (e.g., a Blu-ray disc, a CD, a DVD, etc.) or any other type of removable non-transitory machine-readable storage media such as a USB drive 832. For example, the optical disc 830 and/or the USB drive 832 may store the machine-readable instructions 806 thereon and provide the machine-readable instructions 806 to the electronic platform 800 via the interface(s) 820.

Techniques operating according to the principles described herein may be implemented in any suitable manner. The processing and decision blocks of the flowcharts above represent steps and acts that may be included in algorithms that carry out these various processes. Algorithms derived from these processes may be implemented as software integrated with and directing the operation of one or more single- or multi-purpose processors, may be implemented as functionally equivalent circuits such as a DSP circuit or an ASIC, or may be implemented in any other suitable manner. It should be appreciated that the flowcharts included herein do not depict the syntax or operation of any particular circuit or of any particular programming language or type of programming language. Rather, the flowcharts illustrate the functional information one skilled in the art may use to fabricate circuits or to implement computer software algorithms to perform the processing of a particular apparatus carrying out the types of techniques described herein. For example, the flowcharts, or portion(s) thereof, may be implemented by hardware alone (e.g., one or more analog or digital circuits, one or more hardware-implemented state machines, etc., and/or any combination(s) thereof) that is configured or structured to carry out the various processes of the flowcharts. In some examples, the flowcharts, or portion(s) thereof, may be implemented by machine-executable instructions (e.g., machine-readable instructions, computer-readable instructions, computer-executable instructions, etc.) that, when executed by one or more single- or multi-purpose processors, carry out the various processes of the flowcharts. It should also be appreciated that, unless otherwise indicated herein, the particular sequence of steps and/or acts described in each flowchart is merely illustrative of the algorithms that may be implemented and can be varied in implementations and embodiments of the principles described herein.

Accordingly, in some embodiments, the techniques described herein may be embodied in machine-executable instructions implemented as software, including as application software, system software, firmware, middleware, embedded code, or any other suitable type of computer code. Such machine-executable instructions may be generated, written, etc., using any of a number of suitable programming languages and/or programming or scripting tools, and also may be compiled as executable machine language code or intermediate code that is executed on a framework, virtual machine, or container.

Machine-executable instructions (e.g., processor-executable instructions) implementing the techniques described herein may, in some embodiments, be encoded on one or more computer-readable media, machine-readable media, etc., to provide functionality to the media. Computer-readable media, machine-readable media, etc., include magnetic media such as a hard disk drive, optical media such as a CD or a DVD, a persistent or non-persistent solid-state memory (e.g., Flash memory, Magnetic RAM, etc.), or any other suitable storage media. Such a computer-readable medium, a machine-readable medium, etc., may be implemented in any suitable manner. As used herein, the terms “computer-readable media” (also called “computer-readable storage media”), “computer-readable medium” (also called “computer-readable storage medium”), “machine-readable media” (also called “machine-readable storage media”), and “machine-readable medium” (also called “machine-readable storage medium”) refer to tangible storage media. Tangible storage media are non-transitory and have at least one physical, structural component. In a “computer-readable medium” and “machine-readable medium” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium, a machine-readable medium, etc., may be altered during a recording process.

Embodiments have been described where the techniques are implemented in circuitry and/or machine-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

Various aspects are described in this disclosure, which include, but are not limited to, the following aspects:
1. An apparatus for ultraviolet (UV) radiation generation comprising: a microwave cavity comprising an electrodeless UV bulb, the electrodeless UV bulb comprising a bulb fill capable of emitting UV light; a synthesizer configured to generate a microwave signal; and a solid-state amplifier configured to amplify the microwave signal to generate an amplified microwave signal for igniting the bulb fill to emit UV light.
2. The apparatus of aspect 1, further comprising a controller coupled to at least one of the synthesizer or the solid-state amplifier.
3. The apparatus of aspect 2, wherein the controller is configured to output a control signal to the synthesizer to cause the synthesizer to adjust at least one of an amplitude, a frequency, an intensity, a phase, or a duty cycle of the microwave signal.
4. The apparatus of aspect 2, wherein the controller is configured to output a control signal to the solid-state amplifier to cause the solid-state amplifier to adjust an amplitude of the amplified microwave signal.
5. The apparatus of aspect 4, wherein the controller is configured to: generate the control signal in accordance with one or more ignition parameters associated with the bulb fill, and output the control signal to iteratively drive the solid-state amplifier to adjust the amplitude of the amplified microwave signal to meet or exceed a first amplitude threshold for a first time period and meet or fall below a second amplitude threshold for a second time period, after the first time period.
6. The apparatus of aspect 1, wherein the bulb fill is capable of emitting UV light in a range of 200 nanometers (nm) to 500 nm.
7. The apparatus of aspect 1, wherein the synthesizer is configured to generate the microwave signal to have a frequency in a range of 2.3 gigahertz (GHz) to 2.6 GHz.
8. The apparatus of aspect 1, wherein the synthesizer is configured to generate the microwave signal based on a type of the bulb fill.
9. The apparatus of aspect 1, wherein the synthesizer is a first synthesizer configured to generate the microwave signal as a first microwave signal having a first frequency, and further comprising a second synthesizer configured to generate a second microwave signal having a second frequency.
10. The apparatus of aspect 9, wherein the second frequency is different from the first frequency, and the first synthesizer and the second synthesizer are configured to generate the first microwave signal and the second microwave signal to form an interference beat pattern associated with the first microwave signal and the second microwave signal.
11. The apparatus of aspect 10, wherein the solid-state amplifier is a first solid-state amplifier coupled to the first synthesizer, and further comprising: a second solid-state amplifier; and a second synthesizer coupled to the second solid-state amplifier and configured to control the second solid-state amplifier independently of control of the first solid-state amplifier by the first synthesizer.
12. The apparatus of aspect 1, wherein the solid-state amplifier is configured to generate the amplified microwave signal to: convert the bulb fill into a plasma; energize the plasma; and sustain the energizing of the plasma for emitting the UV light.
13. The apparatus of aspect 1, wherein the solid-state amplifier is configured to generate the amplified microwave signal to have an output power in a range of 100 Watts (W) to 1500 W.
14. The apparatus of aspect 1, wherein the solid-state amplifier is a first solid-state amplifier, the amplified microwave signal is a first amplified microwave signal, and further comprising: a second solid-state amplifier configured to generate a second amplified microwave signal; and a power combiner configured to combine the first amplified microwave signal and the second amplified microwave signal into a combined amplified microwave signal.
15. The apparatus of aspect 14, wherein the combined amplified microwave signal has an output power in a range of 200 Watts (W) to 3000 W.
16. The apparatus of aspect 1, further comprising: a power coupler coupled to the solid-state amplifier; a power combiner coupled to the power coupler, the power coupler to provide at least one of microwave or radiofrequency energy from the solid-state amplifier to the power combiner; and a conduit coupled to the power combiner and configured to provide output from the power combiner to the electrodeless UV bulb.
17. The apparatus of aspect 16, further comprising a tuner coupled to at least one of the power combiner or the conduit to control an amount of the output from the power combiner provided to the microwave cavity.
18. The apparatus of aspect 16, wherein the conduit is at least one of a cable, a transmission line, a stripline, or a waveguide.
19. A method for generating ultraviolet (UV) radiation comprising: generating a microwave signal; amplifying, with a solid-state amplifier, the microwave signal to generate an amplified microwave signal for output to an electrodeless UV bulb, the electrodeless UV bulb comprising a bulb fill capable of emitting UV light; and igniting the bulb fill to emit UV light, by: (i) driving the solid-state amplifier to generate the amplified microwave signal with a first amplitude meeting or exceeding a first amplitude threshold for a first time period; (ii) driving the solid-state amplifier to generate the amplified microwave signal with a second amplitude meeting or falling below a second amplitude threshold for a second time period, after the first time period; and iteratively performing (i) and (ii) until the bulb fill is ignited.
20. The method of aspect 19, further comprising determining, using a controller, at least one of the first amplitude threshold, the second amplitude threshold, the first time period, or the second time period based on a type of the bulb fill.
21. The method of aspect 20, further comprising determining, using the controller, the type of the bulb fill as a type of bulb fill capable of emitting UV light in a range of 200 nanometers (nm) to 500 nm.
22. The method of aspect 19, wherein generating the microwave signal comprises generating the microwave signal with a synthesizer.
23. The method of aspect 22, wherein generating the microwave signal comprises generating, using the synthesizer, the microwave signal to have a frequency in a range of 2.3 gigahertz (GHz) to 2.6 GHz.
24. The method of aspect 22, wherein generating the microwave signal comprises generating, using the synthesizer, the microwave signal based on a type of the bulb fill.
25. The method of aspect 22, wherein the synthesizer is a first synthesizer configured to generate the microwave signal as a first microwave signal having a first frequency, and further comprising generating, with a second synthesizer, a second microwave signal having a second frequency.
26. The method of aspect 25, wherein the second frequency is different from the first frequency, and the first synthesizer and the second synthesizer generate the first microwave signal and the second microwave signal to form an interference beat pattern associated with the first microwave signal and the second microwave signal.
27. The method of aspect 22, wherein the synthesizer is a first synthesizer, the solid-state amplifier is a first solid-state amplifier, the microwave signal is a first microwave signal, and the amplified microwave signal is a first amplified microwave signal, and further comprising: generating, using a second synthesizer, a second microwave signal independently of the first synthesizer generating the first microwave signal; and generating, using a second solid-state amplifier, a second amplified microwave signal independently of the first solid-state amplifier generating the first amplified microwave signal.
28. The method of aspect 22, further comprising: outputting, using a controller, a control signal to the synthesizer; and adjusting, by the synthesizer and in response to the control signal, at least one of an amplitude, a frequency, an intensity, a phase, or a duty cycle of the microwave signal.
29. The method of aspect 19, further comprising: outputting, using a controller, a control signal to the solid-state amplifier; and adjusting, by the solid-state amplifier, an amplitude of the amplified microwave signal.
30. The method of aspect 19, further comprising using the amplified microwave signal to: convert the bulb fill into a plasma; energize the plasma; and sustain the energizing of the plasma for emitting the UV light.
31. The method of aspect 19, wherein generating the amplified microwave signal comprises generating the amplified microwave signal to have an output power in a range of 100 Watts (W) to 1500 W.
32. The method of aspect 19, wherein the solid-state amplifier is a first solid-state amplifier, the amplified microwave signal is a first amplified microwave signal, and further comprising: generating, using a second solid-state amplifier, a second amplified microwave signal; and combining, using a power combiner, the first amplified microwave signal and the second amplified microwave signal into a combined amplified microwave signal.
33. The method of aspect 32, wherein the combined amplified microwave signal has an output power in a range of 200 Watts (W) to 3000 W.
34. The method of aspect 19, further comprising: providing at least one of microwave or radiofrequency energy from the solid-state amplifier to a power combiner; and providing, using a conduit coupled to the power combiner, output from the power combiner to the electrodeless UV bulb.
35. The method of aspect 34, further comprising controlling, using a tuner coupled to at least one of the power combiner or the conduit, an amount of the output from the power combiner provided to the electrodeless UV bulb.
36. A system for ultraviolet (UV) radiation generation comprising: a microwave cavity comprising an electrodeless UV bulb, the electrodeless UV bulb comprising a bulb fill capable of emitting UV light; a synthesizer configured to generate a microwave signal; a solid-state amplifier configured to amplify the microwave signal to generate an amplified microwave signal; and a conduit configured to provide the amplified microwave signal to the electrodeless UV bulb for igniting the bulb fill to emit UV light.
37. The system of aspect 36, wherein the conduit is at least one of a cable, a transmission line, a stripline, or a waveguide.
38. The system of aspect 36, further comprising a controller to control at least one of the synthesizer or the solid-state amplifier.
39. The system of aspect 36, wherein the synthesizer is a first synthesizer, and further comprising a second synthesizer.
40. The system of aspect 36, wherein the solid-state amplifier is a first solid-state amplifier, and further comprising a second solid-state amplifier.
41. The system of aspect 40, further comprising: a first power coupler coupled to the first solid-state amplifier; a second power coupler coupled to the second solid-state amplifier; and a power combiner coupled to the first power coupler and the second power coupler, the power combiner configured to combine a first output of the first power coupler and a second output of the second power coupler into a combined output, and the conduit is coupled to the power combiner and configured to provide the combined output to the electrodeless UV bulb.
42. The system of aspect 41, further comprising a tuner coupled to at least one of the power combiner or the conduit to control an amount of the combined output provided to the microwave cavity.
43. An apparatus comprising at least one memory storing processor executable instructions, and at least one hardware processor configured to execute the processor executable instructions to perform the method of any one of aspects 19-35.
44. At least one computer-readable storage medium storing processor executable instructions that, when executed by at least one hardware processor, cause the at least one hardware processor to perform the method of any one of aspects 19-35.
45. A system comprising at least one hardware processor, and at least one computer-readable storage medium storing processor executable instructions that, when executed by the at least one hardware processor, cause the at least one hardware processor to perform the method of any one of aspects 19-35.

1. An apparatus for ultraviolet (UV) radiation generation comprising:
a microwave cavity comprising an electrodeless UV bulb, the electrodeless UV bulb comprising a bulb fill capable of emitting UV light;
a synthesizer configured to generate a microwave signal; and
a solid-state amplifier configured to amplify the microwave signal to generate an amplified microwave signal for igniting the bulb fill to emit UV light.

2. The apparatus of claim 1, further comprising a controller coupled to at least one of the synthesizer or the solid-state amplifier.

3. The apparatus of claim 2, wherein the controller is configured to output a control signal to the synthesizer to cause the synthesizer to adjust at least one of an amplitude, a frequency, an intensity, a phase, or a duty cycle of the microwave signal.

4. The apparatus of claim 2, wherein the controller is configured to output a control signal to the solid-state amplifier to cause the solid-state amplifier to adjust an amplitude of the amplified microwave signal.

5. The apparatus of claim 4, wherein the controller is configured to:
generate the control signal in accordance with one or more ignition parameters associated with the bulb fill, and
output the control signal to iteratively drive the solid-state amplifier to adjust the amplitude of the amplified microwave signal to meet or exceed a first amplitude threshold for a first time period and meet or fall below a second amplitude threshold for a second time period, after the first time period.

6. The apparatus of claim 1, wherein the synthesizer is configured to generate the microwave signal to have a frequency in a range of 2.3 gigahertz (GHz) to 2.6 GHz.

7. The apparatus of claim 1, wherein the synthesizer is a first synthesizer configured to generate the microwave signal as a first microwave signal having a first frequency, and further comprising a second synthesizer configured to generate a second microwave signal having a second frequency.

8. The apparatus of claim 7, wherein the second frequency is different from the first frequency, and the first synthesizer and the second synthesizer are configured to generate the first microwave signal and the second microwave signal to form an interference beat pattern associated with the first microwave signal and the second microwave signal.

9. The apparatus of claim 8, wherein the solid-state amplifier is a first solid-state amplifier coupled to the first synthesizer, and further comprising:
a second solid-state amplifier; and
a second synthesizer coupled to the second solid-state amplifier and configured to control the second solid-state amplifier independently of control of the first solid-state amplifier by the first synthesizer.

10. A method for generating ultraviolet (UV) radiation comprising:
generating a microwave signal;
amplifying, with a solid-state amplifier, the microwave signal to generate an amplified microwave signal for output to an electrodeless UV bulb, the electrodeless UV bulb comprising a bulb fill capable of emitting UV light; and
igniting the bulb fill to emit UV light, by:
(i) driving the solid-state amplifier to generate the amplified microwave signal with a first amplitude meeting or exceeding a first amplitude threshold for a first time period;
(ii) driving the solid-state amplifier to generate the amplified microwave signal with a second amplitude meeting or falling below a second amplitude threshold for a second time period, after the first time period; and
iteratively performing (i) and (ii) until the bulb fill is ignited.

11. The method of claim 10, further comprising determining, using a controller, at least one of the first amplitude threshold, the second amplitude threshold, the first time period, or the second time period based on a type of the bulb fill.

12. The method of claim 11, further comprising determining, using the controller, the type of the bulb fill as a type of bulb fill capable of emitting UV light in a range of 200 nanometers (nm) to 500 nm.

13. The method of claim 10, wherein generating the microwave signal comprises generating the microwave signal with a first synthesizer configured to generate the microwave signal as a first microwave signal having a first frequency, and further comprising generating, with a second synthesizer, a second microwave signal having a second frequency.

14. The method of claim 13, wherein the second frequency is different from the first frequency, and the first synthesizer and the second synthesizer generate the first microwave signal and the second microwave signal to form an interference beat pattern associated with the first microwave signal and the second microwave signal.

15. The method of claim 13, wherein the solid-state amplifier is a first solid-state amplifier, the microwave signal is a first microwave signal, and the amplified microwave signal is a first amplified microwave signal, and further comprising:
generating, using a second synthesizer, a second microwave signal independently of the first synthesizer generating the first microwave signal; and
generating, using a second solid-state amplifier, a second amplified microwave signal independently of the first solid-state amplifier generating the first amplified microwave signal.

16. The method of claim 13, further comprising:
outputting, using a controller, a control signal to the first synthesizer; and
adjusting, by the synthesizer and in response to the control signal, at least one of an amplitude, a frequency, an intensity, a phase, or a duty cycle of the microwave signal.

17. The method of claim 10, further comprising:
outputting, using a controller, a control signal to the solid-state amplifier; and
adjusting, by the solid-state amplifier, an amplitude of the amplified microwave signal.

18. The method of claim 10, further comprising using the amplified microwave signal to:
convert the bulb fill into a plasma;
energize the plasma; and
sustain the energizing of the plasma for emitting the UV light.

19. A system for ultraviolet (UV) radiation generation comprising:
a microwave cavity comprising an electrodeless UV bulb, the electrodeless UV bulb comprising a bulb fill capable of emitting UV light;
at least one synthesizer configured to generate a microwave signal;
at least one solid-state amplifier configured to amplify the microwave signal to generate an amplified microwave signal; and
a conduit configured to provide the amplified microwave signal to the electrodeless UV bulb for igniting the bulb fill to emit UV light.

20. The system of claim 19, wherein the at least one solid-state amplifier comprises a first solid-state amplifier and a second solid-state amplifier, and the system further comprising:
a first power coupler coupled to the first solid-state amplifier;
a second power coupler coupled to the second solid-state amplifier; and
a power combiner coupled to the first power coupler and the second power coupler, the power combiner configured to combine a first output of the first power coupler and a second output of the second power coupler into a combined output, and
the conduit is coupled to the power combiner and configured to provide the combined output to the electrodeless UV bulb.
